(19) United States
(12) Patent Application Publication
(10) Pub. No.: US 2007/0095995 A1
(43) Pub. Date: May 3, 2007

(54) Guttering

(76) Inventor: Brian John Higgins, New South Wales (AU)

Correspondence Address: THE WEBB LAW FIRM, P.C., 700 KOPPERS BUILDING, 436 SEVENTH AVENUE, PITTSBURGH, PA, 15219, US

(21) Appl. No.: 10/553,666

(22) PCT Filed: Apr. 15, 2004
(86) PCT No.: PCT/AU04/00500

§ 371 Date: Aug. 1, 2006

(30) Foreign Application Priority Data
Apr. 17, 2003 (AU) 2003901830
Aug. 6, 2003 (AU) 2003904124

(51) Int. Cl. A47F 5/00; A47H 1/10; F16B 45/00

(52) U.S. Cl. 248/300; 248/301; 248/304

(57) ABSTRACT

A mounting bracket for a gutter for buildings, the gutter including a generally channel or trough shaped body for collecting water with an internal wall having mounting means thereon, the mounting bracket including an elongated bracket body which includes an attachment section which is attachable to the building and a gutter mounting section, the gutter mounting section including a plurality of gutter support elements arranged along the gutter mounting section and aligned so as to correspond to a fall required when the gutter is in an installed position.

This invention relates generally to guttering for buildings and the like and to components therefor.

One form of currently known guttering includes a channel shaped body which is adapted to be mounted to a building by a series of separate support brackets. A problem associated with existing guttering is that it is a relatively time consuming task to mount the guttering to the building because of the requirement that the guttering has a proper fall enabling water in the guttering to be directed to the down pipe. This requires the setting of a'string line at the desired fall angle and thereafter mounting brackets correctly so that the channel will follow the fall line.

It is an object of present invention to provide improvements to guttering which alleviates one or more of the aforementioned disadvantages.

According to one aspect of the present invention there is provided a mounting bracket for a gutter for buildings, the gutter including a generally channel or trough shaped body for collecting water with an internal wall having mounting means thereon, the mounting bracket including an elongated bracket body which includes an attachment section which is attachable to the building and a gutter mounting section, the gutter mounting section including a plurality of gutter support elements arranged along the gutter mounting section and aligned so as to correspond to a fall required when the gutter is in an installed position.

In one preferred form, the elongated bracket body includes a generally U-shaped portion one leg thereof being the attachment section and the other leg thereof being the gutter mounting section. Preferably, the legs of the U-shaped portion are spaced apart so as to provide a recess therebetween for receiving part of the internal wall of the gutter therein when the gutter is in the installed position.

The gutter support elements may, in one form include projections which extend into the recess and are adapted to cooperate with the mounting means on the internal wall of the gutter so as to retain the gutter in the installed position. The mounting means on the internal wall of the gutter may be in the form of a raised elongated rib which in the installed position is disposed within the recess and inhibited from removal by said projections. Preferably, the projections are hook-like elements pressed or punched out of the gutter mounting section.

The mounting bracket may further include a plurality of access apertures in the gutter mounting section for providing access to the attachment section when it is being attached to the building.

Preferred embodiments of the invention will hereinafter be described with reference to the accompanying drawings and in those drawings:

FIG. 1 is a schematic isometric illustration of a gutter mounting bracket according to one preferred embodiment of the present invention;

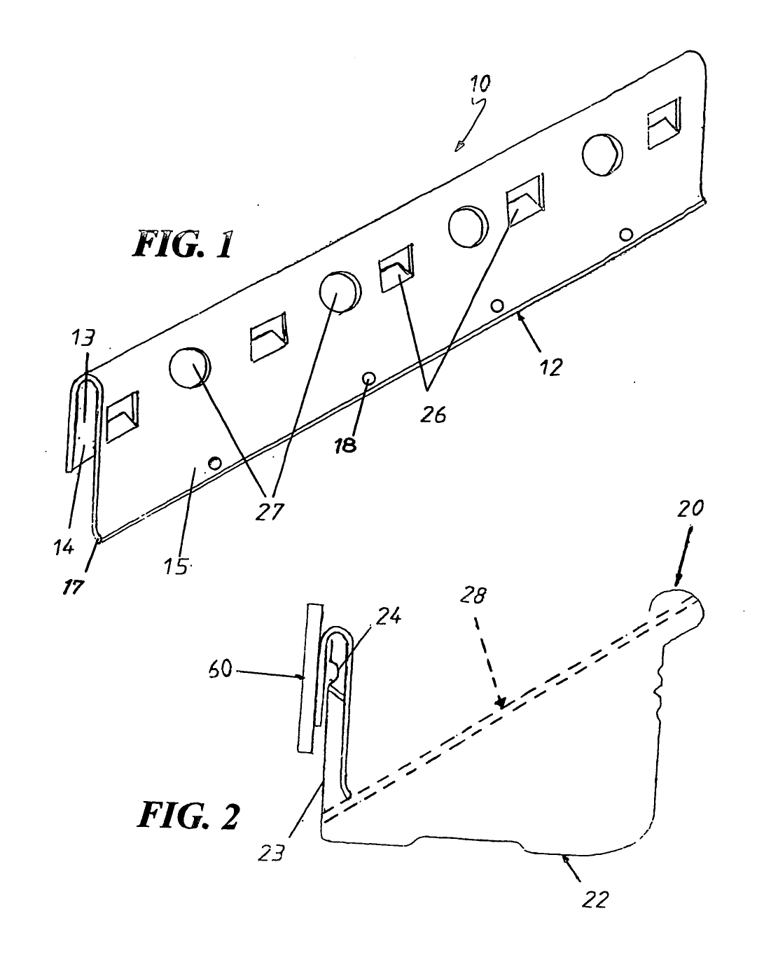

FIG. 2 is a schematic side view of the bracket shown in FIG. 1 and a gutter in an installed position.

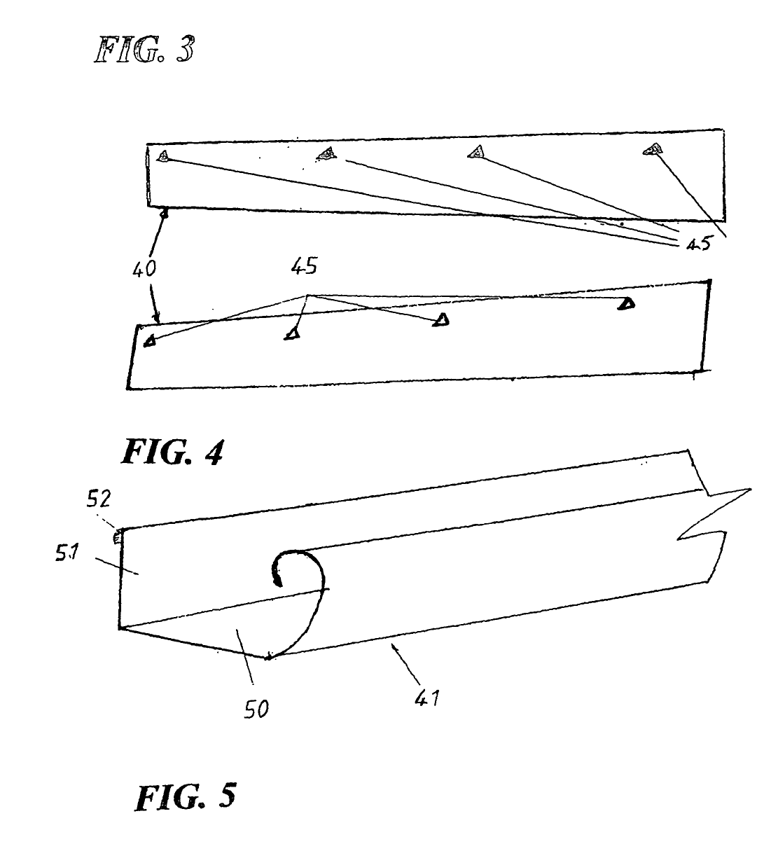

FIGS. 3 and 4 are side views of gutter mounting brackets according to other embodiments of the present invention;

FIG. 5 is a schematic view of a gutter suitable for use with the brackets shown in FIGS. 3 and 4;

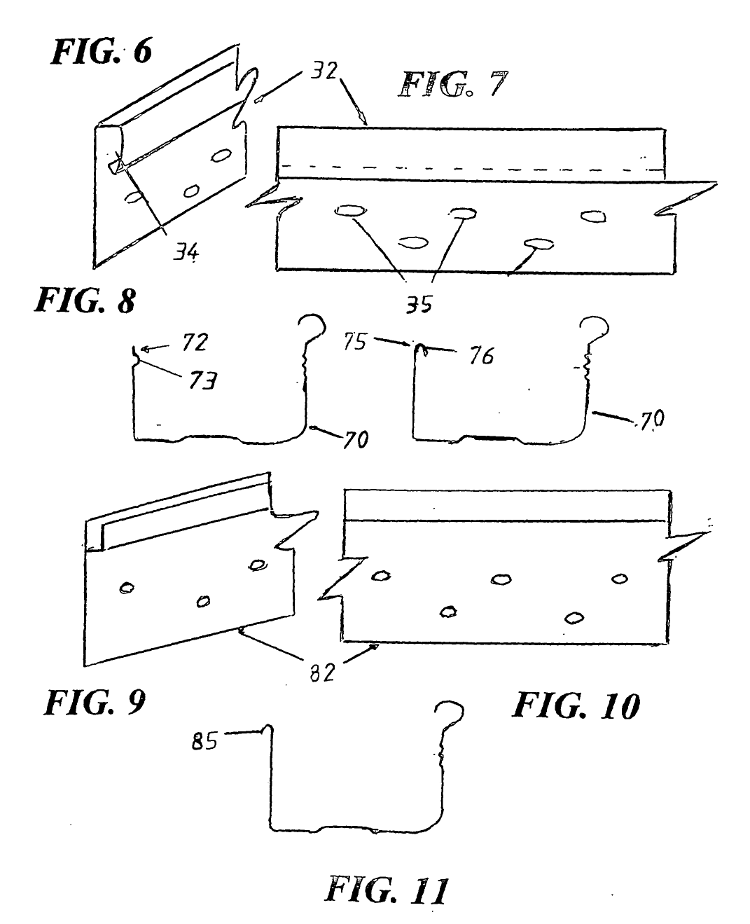

FIGS. 6 and 7 are schematic views of a bracket and gutter according to another embodiment of the invention; and

FIGS. 8 and 9 are schematic views of a gutter and bracket according to further embodiments of the invention.

Referring to FIGS. 1 and 2 there is shown a mounting bracket 10 for a gutter 20 for buildings. As shown in FIG. 2 the gutter 20 includes a generally channel shaped body 22 for collecting water with an internal wall 23 having mounting means 24 thereon. The mounting bracket 10 includes an elongated bracket body 12 which includes an attachment section 14 which is attachable to the building which as shown in this example is fascia 60 and a gutter mounting section. It could be also attached to other parts of the building such as the wall or rafter. The gutter mounting section including a plurality of gutter support elements arranged along the gutter mounting section and aligned so as to correspond to a fall required when the gutter is in an installed position.

The elongated bracket body includes a generally U-shaped portion one leg thereof being the attachment section 14 and the other leg thereof being the gutter mounting section 15. The legs of the U-shaped portion are spaced apart so as to provide a recess 13 therebetween for receiving part of the internal wall of the gutter therein when the gutter is in the installed position. The free end 17 of gutter mounting section 15 is inclined with respect to the plane of the section providing a lead-in guide when installing the gutter.

The gutter support elements include projections 26 which extend into the recess 13 and are adapted to cooperate with the mounting means on the internal wall of the gutter so as to retain the gutter in the installed position. The mounting means on the internal wall of the gutter is a raised elongated rib 24 which in the installed position is disposed within the recess and inhibited from removal by said projections. Because section 15 extends well into the gutter when installed this reduces the prospect of uplift of the gutter. Furthermore, if desired, high tensile rods 28 may be provided at spaced intervals along the gutter for increased stability.

The projections are hook-like elements pressed or punched out of the gutter mounting section. A plurality of access apertures 27 are provided in the gutter mounting section for providing access to the attachment section when it is being attached to the building. Below each aperture 27 is a bleed hole 18 for enabling water to escape from the recess 13.

Referring to FIGS. 3 to 5 there is shown two further forms mounting bracket 40 and a gutter 41. The mounting bracket 40 includes a sheet having mounting projections 45 thereon. The sheet is tapered from one end to the other and adapted to be secured to a wall or fascia of the building with the mounting projections 45 being aligned so as correspond to the fall required in the liquid collecting section of the gutter assembly. It will be appreciated that by aligning the lower edge of the sheets shown in FIGS. 3 and 4 with an edge of the fascia, the mounting projections will be inclined relative to that edge. That is, a line extending through the projections from one end of the sheet to the other will conform to the required fall of the liquid collecting section of the guttering assembly. The gutter 41 as shown in FIG. 5 includes a trough like channel 50 having an internal side wall 51 which can be mounted to the mounting projections 45 so that in an installed position the liquid collecting section is disposed at the selected fall of gutter assembly.

The mounting projections 45 are triangular or square shaped hook like elements pressed or punched out of the mounting section. The hook-like elements are adapted to cooperate with a hook shaped edge portion 52 on internal side wall at the upper edge thereof so that the gutter can be attached to the mounting section. Strap elements (not shown) may be disposed along the length of the guttering to support the gutter particularly when it contains water.

Referring to FIGS. 6 to 8 there is shown another form of mounting bracket and guttering according to the present invention. In this particular form there is provided a mounting bracket 32 and gutter 70 two forms of which are illustrated in FIGS. 8(a) and 8(b). The mounting bracket 32 is in the form of a sheet which is adapted to be secured to a wall or fascia of a building by fastenings which cooperate with mounting apertures 35. The upper edge of the sheet has a spring clip section 34 thereon which is adapted to receive coupling section 73 on the gutter 70. As shown the coupling section can be in the form of a protuberance 73 or hook shaped flange 76. The coupling section 34 is adapted to snap fit into the clip section 75.

In the embodiment of FIGS. 9 and 10 the mounting bracket 82 has a U-shaped flange formed along its upper edge which is adapted to receive a hook like coupling section 85 on the gutter (FIG. 11).

Finally, it is to be understood that various alterations, modifications and/or additions may be incorporated into the various constructions and arrangements of parts without departing from the spirit or ambit of the invention.

1-6. (canceled)

7. A mounting bracket for a gutter for buildings, the gutter including a generally channel or trough shaped body for collecting water with an internal wall having a gutter mounting thereon, the mounting bracket including an elongated bracket body which includes an attachment section which is attachable to the building and a gutter mounting section, the gutter mounting section including a plurality of gutter retaining clips arranged along with the gutter mounting section, the arrangement being such that when the bracket is attached to the building the clips are aligned so as to correspond to a fall required when the gutter is in an installed position, the retaining clips being adapted to cooperate with the gutter mounting to retain the gutter in the installed position.

8. A mounting bracket according to claim 7, wherein said elongated bracket body includes a generally U-shaped portion, one leg thereof being the attachment section and the other leg thereof being the gutter mounting section, the legs of the U-shaped portion being spaced apart so as to provide a recess therebetween for receiving part of the internal wall of the gutter therein when the gutter is in the installed position.

9. A mounting bracket according to claim 8, wherein the gutter retaining clips include projections which extend into the recess and are adapted to cooperate with the mounting means on the internal wall of the gutter so as to retain the gutter in the installed position.

10. A mounting bracket according to claim 9, wherein the mounting means on the internal wall of the gutter is a raised elongated rib which in the installed position is disposed within the recess and inhibited from removal by said projections.

11. A mounting bracket according to claim 9, wherein said projections are hook-like elements pressed or punched out of the gutter mounting section.

12. A mounting bracket according to claim 8, further including a plurality of access apertures in the gutter mounting section for providing access to the attachment section when it is being attached to the building.
